(19) United States
(12) Patent Application Publication
(10) Pub. No.: US 2009/0158403 A1
(43) Pub. Date: Jun. 18, 2009

(54) METHOD AND SYSTEM FOR PERMITTING OR DENYING SERVICE

(76) Inventors: Dirk Leonard Benschop, Etten-Leur (NL); Henderik Reinout Benchop, Rozenburg (NL)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 11/956,572

(22) Filed: Dec. 14, 2007

(51) Int. Cl. G06F 21/00

(52) U.S. Cl. 726/5

(57) ABSTRACT

Aspects of the invention relate to a computer-implemented method and system of permitting or denying service for a user device of a user of a service in relation to a recipient, who is the counterparty, is proposed. The method is executed in a system configured for connecting to the user device. The system is configured for accessing a recipient requirement list of the recipient and a user profile of the user. The recipient requirement list comprises at least one criterion regarding an item of said user profile. A service request is received from the user device. The service request contains an identifier of the recipient. The recipient requirement list is traced on the basis of this identifier. Subsequently, it is checked whether an item of the user profile satisfies the at least one criterion of the traced recipient requirement list. Service is permitted if the item of the user profile satisfies said at least one criterion of said recipient requirement list. Service initiation or service establishment is denied if said item of said user profile does not satisfy said at least one criterion of said recipient requirement list.

### BACKGROUND

The discussion below is merely provided for general background information and is not intended to be used as an aid in determining the scope of the claimed subject matter.

Aspects of the invention relate to the field of electronic services. More specifically, Aspects of the invention relate to the field of permitting and/or denying initiation and/or establishment of services.

The use of communication devices for electronic services has become very popular in the last two decades. Mobile telephony and electronic banking are examples of electronic services that heavily penetrated the daily life of people. Other examples include electronic mail and use of the internet, such as visiting web pages with information, participating in electronic friends networks and contributing to web discussions. Apart from these electronic services, regular mail systems for letters or parcels still fulfil a need. Services also include navigation services, wherein e.g. a vehicle is navigated from a first location to a second location.

The ever increasing possibilities of electronic services go along with a significant amount of information people need to possess to make use of these electronic services. As a typical example, one needs to know a telephone number for contacting another person by telephone, an e-mail address to send an e-mail to this same person, an uniform resource locator (URL) to visit the website of this person, a bank account number to wire money to the bank account of this person etc. Moreover, to send a letter to a person, one needs to know the address of this person. This same is true for navigation services.

On the other hand, people do not like to disclose all these contact details to the general public. Some contact details, such as a telephone number, home address and a bank account number are preferred to be kept secret for most people, while other details, such as a URL of a website or a business address, are allowed to be conveyed to as many people as possible.

The variety of electronic services also makes people vulnerable to having undesired contacts with others. It is known in the art that a user of a system denies or allows other people to communicate with him by, respectively, blacklisting or white listing these people on the basis of e.g. a telephone number. An example is provided in US 2006/0147014. Also the MSN web conversation platform of Microsoft allows blocking of contacts. Furthermore, a non-prepublished international patent application PCT/NL2007/050553 of the applicant has been filed, wherein use of a personal identifier is described.

However, the granularity of these methods and systems is rather coarse, essentially only allowing people to either communicate or not communicate with each other on the basis of a device identifier or a personal identifier.

Consequently, there exists a need in the art to provide an improved service initiation and/or service establishment method and system.

### SUMMARY

This Summary and Abstract are provided to introduce some concepts in a simplified form that are further described below in the Detailed Description. This Summary and Abstract are not intended to identify key features or essential features of the claimed subject matter, nor are they intended to be used as an aid in determining the scope of the claimed subject matter. In addition, the description herein provided and the claimed subject matter should not be interpreted as being directed to addressing any of the short-comings discussed in the Background.

A computer-implemented method of permitting or denying communication service initiation for a user device of a user of a service in relation to a recipient, who may be the counterparty or destination party, is proposed. The method is executed in a system configured for connecting to the user device. The system is configured for accessing a recipient requirement list of the recipient and a user profile of the user. The recipient requirement list comprises at least one criterion regarding an item of said user profile. A service request is received from the user device. The service request contains an identifier of the recipient. The recipient requirement list is traced on the basis of this identifier. Subsequently, it is checked whether an item of the user profile satisfies the at least one criterion of the traced recipient requirement list. Service initiation is permitted if the item of the user profile satisfies said at least one criterion of said recipient requirement list. Service initiation or service establishment is denied if said item of said user profile does not satisfy said at least one criterion of said recipient requirement list.

Moreover a computer program such as embodied on a computer readable medium (e.g. computer storage medium) for executing the method and a carrier therefore are proposed.

The applicant also proposes a system configured for permitting or denying service initiation. The system is configured for connecting with a user device of a user in relation to a recipient (the counterparty for the service). The system comprises a receiver configured for receiving a service request from the user device. The service request contains an identifier of the recipient. Moreover, the system comprises a tracer and an analyzer. The tracer is configured for tracing a recipient requirement list of the recipient on the basis of the identifier. The recipient requirement list comprises at least one criterion regarding an item of a user profile, The analyzer is configured for analyzing whether the item of the user profile satisfies the at least one criterion of the traced recipient requirement list. A service initiator is provided for permitting the service initiation if the item of the user profile satisfies the at least one criterion of said recipient requirement list. The service initiator is configured for denying the service initiation or service establishment if the item of the user profile does not satisfy the at least one criterion of said recipient requirement list.

The proposal of the applicant allows for a finely tuned decision process whether or not a service should be initiated or established on the basis of a requirement list of the recipient and a user profile of the user of the service. Services include telephony services, electronic mail services, regular mail services, web browsing services, media streaming services and navigation services. The recipient/destination party is thus totally in control of his contacts by setting the criteria of his requirement list. A greater degree of differentiation is possible as compared to prior art blacklisting or white listing approaches, wherein the identifier of the device (e.g. a telephone number) is used to permit or deny initiation of a telephone connection. The proposal relates to permitting or denying service using information (items and criteria) that is usually irrelevant for initiating or establishing a connection for the service.

While the above situation relates to a check of the item of the user profile against a criterion of the recipient requirement list, the embodiment of claims 2 and 24 also requires a check in the opposite direction, i.e. whether or not an item of the recipient profile matches a corresponding criterion of the user requirement list. The first situation is advantageously used in blacklisting and white listing approaches (where the initiative is mainly with the recipient) whereas the second situation relates to a handshake or mutual approval situation, wherein the differentiated approach can be used to advantage. The mutual approval situation has been described for telephony services using a personal identifier in the non-prepublished international patent application PCT/NL2007/050553 of the applicant and is herewith incorporated in the present patent application by reference in its entirety.

The user requirement list can be obtained from a user identifier received from the recipient or from login data of the user as defined in claims 3 and 25.

The system may be configured for initiation of a plurality of services, including telephony services, IP telephony services (e.g. VoIP), electronic messaging services, video streaming services, web browsing services and payment services, regular mail services and navigation services. The embodiments of claims 4, 5, 26 and 27 provide the advantage that a combination of an item of a profile and a corresponding criterion of a requirement list may be applicable for at least two services. The proposed method and system allows that non-fulfillment of criteria of a requirement list has consequences for various services. As an example, if an item of a profile indicates that the owner of this profile is an e-mail spammer, this may not only influence the use of e-mail services, but also of other services, such as a telephony service and/or a regular mail service. Services for which criteria of a requirement list apply can be selected in accordance with the embodiments of claims 6 and 28.

Contact identifiers of recipients may include device contact identifiers, e.g. a telephone number, a MAC address and an IP address, and personal contact identifiers, e.g. an e-mail address or a login name. At least one of the criteria of the requirement list(s) is independent of these contact identifiers and therefore provides the possibility of a greater degree of differentiation as defined in the embodiments of claims 7 and 29.

Items from the profile(s) may be system items and/or user defined items in accordance with the embodiments of claims 8 and 30. System items relate to the behaviour of the user and/or recipient on the system. A particular example of a system item is the spam behaviour of the user and/or recipient on the system as defined in claims 9 and 31. The spam behaviour in the system can be registered as a result of one or more spam notification signals received from addressees of e.g. an electronic message. These methods and systems have been described in the non-prepublished international patent applications PCT/NL2007/050557 and PCT/NL2007/050555 which are incorporated in the present application by reference in its entirety. User defined items (and the corresponding criteria) relate to items and criteria not presented as default by the system. Such user defined items provide greater flexibility for the users and recipients.

Of course, items of the profile list(s) may be empty, correct or incorrect. The embodiments of claims 10 and 32 allow for a differentiation of verified items and unverified items. There is a high probability of correctness for verified items, whereas for unverified items the probability of correctness is unpredictable. The embodiments of claims 11 and 33 allow the users and/or recipients to indicate whether the item checked against a criterion of the requirement list of the user and/or recipient should be a verified item. This feature reduces the chance that that a user or recipient becomes involved in a service transaction that is not desired or intended.

Items may be blocked from checking against criteria of a requirement list in accordance with the embodiments of claims 12 and 34. The indication of the prevention of such checking of items may be set by default and/or upon indication from a user device. This feature avoids the possibility of undesired fishing expeditions for items of a profile by submitting various service requests to the system and see if the items of the targeted recipient match the criteria of the user requirement list. These embodiments are particularly relevant to the mutual approval situation, but may also apply to black listing and white listing situations. The embodiments of claims 13 and 35 allow a permanent or temporary release of the restrictions applying to the checking of the items.

The embodiments of claims 14-16 and 36-38 allow that a single identifier, viz. a public unique identifier (PUID) can be used for a variety of services. The single PUID can be easily remembered and used for a combination of services. The PUID is by definition a public identifier. Such service systems exist, e.g. the ENUM initiative (www.enum.nl), but these system are vulnerable to abuse. The method and system as proposed in the present application allow for a reduction of this abuse by allowing items and criteria to be set before a service is initiated, established or fulfilled. The PUID may be any combination of (alpha)numerical symbols. However, it may already be sufficient to use 5 or 6 letters (both upper-cast and lower-cast) to obtain a large amount of unique PUIDS.

First and second services (e.g. a payment service and a communication service) can be enjoyed with a single device. The proposal has the potential of a new and inventive payment system making other forms of payment, such as payment systems using cards, ATM's, payment by mobile phones using RFID technology etc., redundant. The proposal allows a user to use a mobile phone for using payment services that can also be used for other communication services. URL's may also be no longer required for web browsing.

The embodiments of claims 17 and 39 provide the advantage that the personal contact information (such as the bank account number and the telephony number, the electronic message address and the URL) is known only within the system and need not to be known outside this system. The conversion of the single PUID into such personal contact information in dependence of the type of service allows people to use e.g. the payment service and/or the communication service without knowing these personal details. Connection may be made to an external payment service and/or an external communication service or an external navigation service. These services are offered outside the server system. The embodiments allow an immediate introduction of the system while people are still using services of external providers.

Of courser services may be offered in the system itself. Although the conversion of the PUID into other identifiers in dependence of the type of service is also possible in such a case, the PUID itself in combination with a message type indication may be used to make use of a service, as provided for by the embodiments of claims 18 and 40.

Users and/or recipients and/or providers may themselves indicate in the system whether they desire to use services from the server system or from external systems.

The embodiments of claims 19 and 41 allow identification of the user of the server system. Preferably, the identification involves a user name and password combination.

The embodiments of claims 20 and 42 reduce the chance of sniffing identities of users of the system.

Hereinafter, embodiments of the invention will be described in further detail. It should be appreciated, however, that these embodiments may not be construed as limiting the scope of protection for the present invention.

### BRIEF DESCRIPTION OF THE DRAWINGS

In the drawings:

FIG. 1 shows a schematic illustration of a server system according to a first embodiment;

FIG. 2 shows a schematic illustration of the electronic device configured for use with the system of FIG. 1;

FIGS. 3A and 3B show schematic illustrations of the system of FIG. 1;

FIG. 4 shows a flow chart in accordance with an embodiment of the invention;

FIGS. 5A and 5B show situations relating to a system comprising profiles and requirement lists.

FIG. 6 shows a schematic illustration of a server system according to a second embodiment;

FIG. 7 shows a contact card of a recipient; and

FIGS. 8-14 show various time diagram illustrating step of embodiments of a method using the system of FIG. 1 and FIG. 6.

### DETAILED DESCRIPTION OF THE ILLUSTRATIVE EMBODIMENT

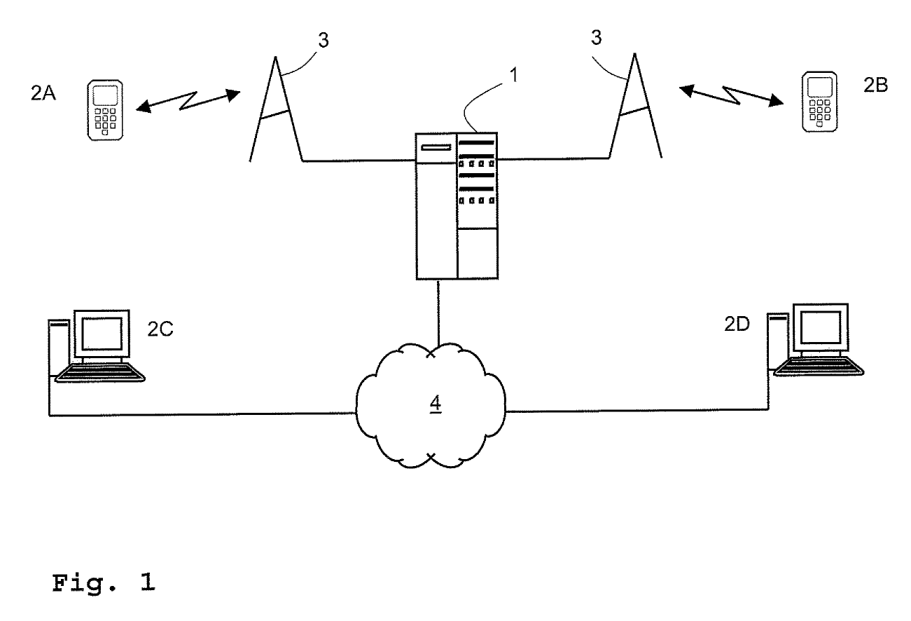

FIG. 1 shows a server system 1 communicatively connected to electronic devices 2A-2D. Mobile devices 2A, 2B are connected via wireless access networks 3 to the server system 1. Stationary devices 2C, 2D are connected via network 4, such as the internet or a local area network, to the server system 1. The network connections may be secured. In the following, it will be assumed that the devices 2A, 2C are used by a user of the server system 1, whereas devices 2B, 2D are devices of a recipient.

Mobile device 2A, schematically shown in FIG. 2, may be a mobile phone comprising a keyboard with a plurality of (numerical and/or alphanumerical) keys 10 and a display 11. Furthermore, the mobile device 2A comprises communication type keys 12A, 12B, 12C and a payment key 12D. The communication type keys 12A-12C enable the user of the mobile device 2A to select e.g. whether he desires to make a telephone call (telephony service), to send an electronic message (electronic messaging service) or to browse a web page on the internet (web communication service). The payment key 12D enables the user to select a payment service. It should be appreciated that the keys 12A-12D are not necessarily separate keys, but may also be implemented otherwise, e.g. by one or more soft keys using the display 11 to indicate the function of the soft key at a particular moment. Selection of a service may also be made from a software menu. It should also be appreciated that the same functionality is possible for a stationary device 2C. Finally, it is noted that the type of service desired by the user of the devices 2A, 2C may also be implicit from the message sent to the server system 1. As an example, if the user device 2A, 2C transmits a money value, it may be implicit that a payment service is requested.

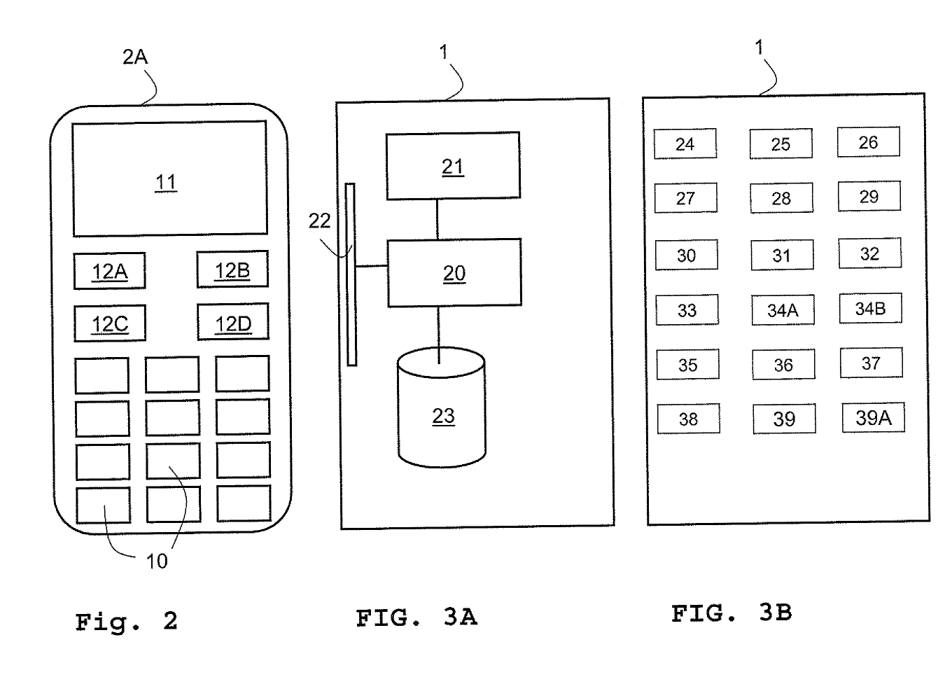

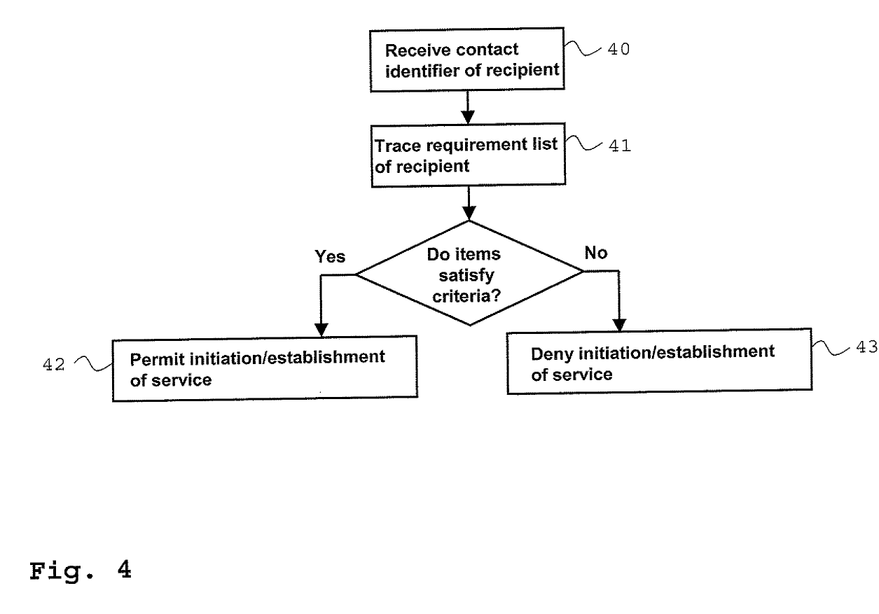

FIGS. 3A and 3B show schematic illustrations of the server system 1.

The server system 1 comprises a processor 20, a memory 21, a network adapter 22 for communication with one or more of the devices 2A-2D via the networks 3, 4 and a relational database 23. It should be appreciated that the server system 1 is normally capable of connecting to more than the four electronic devices 2A-2D shown in FIG. 1.

The specific functions of the server system 1 are schematically illustrated in FIG. 3B and will now be described in further detail. It should be appreciated that the functions may be largely implemented as software code portions of one or more computer programs embodied on one or more computer readable mediums (e.g. computer storage mediums) accessible to and executed on the processor 20 (server 1).

The server system 1 comprises a receiver 24 configured for receiving a contact identifier of the recipient from the user devices 2A, 2C. Identifiers of the users may be received from the recipient devices 2B, 2D. The identifiers may include a telephone number, an e-mail address, a bank account number, a URL, a home address, a navigation location etc. One or more of these identifiers may be replaced by a single identifier, a public unique identifier (PUID). Although any type of identifier may be used, it will be assumed in the following that a PUID is used.

The server system 1 also contains one or more service initiators, such as a payment service initiator 25 and a communication service initiator 26. The payment service initiator 25 is configured for initiating, and possibly establishing, the payment service for making a payment to the recipient on the basis of the PUID (the identifier) of the recipient received by the PUID receiver 24 from the user device 2A, 2C. The communication service initiator 26 is configured for initiating, and possibly establishing, a communication service, such as a telephony service, an electronic message service, a streaming media service and/or a web browsing service for establishing communication with the recipient using the PUID received by the PUID receiver 24 for establishing the communication. The server system may also comprise a regular mail service initiator and/or a navigation service initiator (not shown).

In order to identify the type of service requested by the users of the electronic devices 2A, 2C, the server system 1 has a message receiver 27 configured for receiving a type message from the mobile devices 2A, 2C. The type message may relate to a communication service, a payment service, a regular mail service and a navigation service. The communication service initiator 26 is further configured for initiating the communication service in dependence of the type message. The type of communication requested may also be deduced from other data in the request.

It should be appreciated that a composed message may be received from the user device(s) 2A, 2C containing the PUID of the recipient, the type of service requested and/or other data such as a monetary value for a payment service, an attachment and/or other contents.

The user of the device 2A, 2C may not be aware of the particular contact information, such as a telephone number, a bank account number and/or a home address of the recipient. On the other hand, the recipient may desire to keep this contact information secret. The server system 1 contains a converter 28 configured for converting the PUID to e.g. a payment address identifier (e.g. a bank account number) and/or a communication address identifier (e.g. a telephone number, an e-mail address and/or a URL of a web page) and/or a home address and or a navigation location. The payment address identifier and the communication address identifier need not to be known by the user of the device 2A, 2C, since the PUID is sufficient to make a payment to the recipient and/or to e.g. send an electronic message to the same recipient.

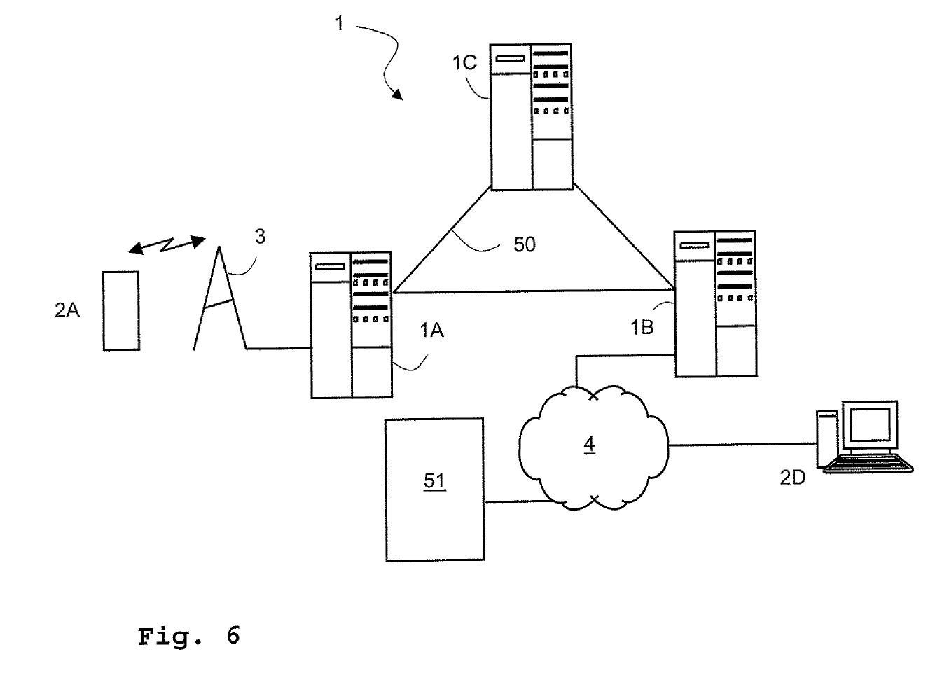

The server system 1 also contains a payment connection module 29 for connecting to a payment system for making use of a payment service using the payment address identifier and a communication connection module 30 for connecting to a communication system for initiating the communication service using the communication address identifier. Other modules included a regular mail connection module and/or a navigation connection module. These modules may be used for recipients using e.g. payment, communication, regular mail and navigation services provided external to the server system 1, as shown in FIG. 6. The server system 1 may have a determination module 31 configured for determining whether the recipient uses the payment service and/or the communication service of the server system 1 or an external system.

Alternatively or in addition, the server system 1 may provide payment and communication services itself using e.g. a payment service module 32 configured for executing payment services for performing payments to the recipient and a communication service module 33 configured for executing communication services for establishing communication with the recipient. The payment service module 32 is configured for initiating the payment service using the PUID as a payment address identifier (i.e. the PUID functions as the bank account number) and the communication service module 33 is configured for initiating the communication service using the PUID as a communication address identifier (i.e. the PUID is e.g. the telephone number, electronic message address or the URL). Other internal service modules may include a regular mail module and/or a navigation module.

The server system 1 also comprises a login module 34A for receiving a login request from the device(s) 2A, 2C. The login request comprises at least one personal identifier in order to identify a user of the device 2A, 2C. Preferably, the user is identified by a combination of a user name and a password. The users are subscribers to the server system 1 in such a case.

The communication with the user devices 2A, 2C may be secured by e.g. secured network connections and/or data encryption techniques. In order to further increase the security, the server system comprises a variable session key issuer 34B. The variable session key issuer is configured for issuing different session keys in response to subsequent requests from the user devices 2A, 2C. The issuer 34B may use random numbers but also outside parameters (such as e.g. a temperature measured by a temperature sensor at a particular location) to obtain the variable keys.

The database 23 of the server system 1 may store profiles containing one or more items (e.g. characteristics of the user) and requirement lists containing one or more criteria from users of the user devices 2A, 2C and/or recipients using devices 2B, 2D. The profiles and requirement lists available to the server system 1 can be used to enable the users and/or the recipients to fine tune conditions under which they want to be involved in a service, e.g. in a payment transaction, a communication service, a regular mail service and/or a navigation service, as a recipient or destination party. It should be appreciated that this manner of enabling and disabling communication differs from the prior art in that the enabling or disabling is not primarily based on a contact identifier of the devices and/or the user.

To that end, the server system 1 comprises a tracer 35 configured for tracing at least one requirement list of a user and/or a recipient. The requirement list of the recipient can be traced using the contact identifier, e.g. the PUID, of the recipient. The same holds for the requirement list of the user, although this list may also be traced on the basis of other data in the request from the user device 2A, 2C.

Furthermore, the server system 1 has an analyser 36 configured for checking whether one or more items of a profile satisfy one or more criteria of a requirement list as will be explained in further detail below. Items and corresponding criteria may relate to a variety of personal details, not being the contact identifier, including age, gender, body characteristics (e.g. hair colour, length), financial details, company details, geographic details (e.g. place of living, place of birth, address, street, p.o. box), personal items (e.g. preferences, such as brand preferences, social preferences (sports, communities, etc.)). Items may be user defined. Preferably, the fulfillment of all criteria by the items is analyzed.

The items and corresponding criteria may also relate to the system, such as e.g. the behaviour of the user and/or recipient on the server system 1. As an example, the server system may set a spam flag as an item in the profile of a user or recipient when this user or recipient has been notified as a spammer. Examples of such notification are provided in the international patent applications PCT/NL2007/050557 and PCT/NL2007/05055 of the applicant which are incorporated in the present patent application by reference in its entirety.

Briefly, these applications describe a system and method of reducing the proliferation of electronic messages in a server system comprising one or more servers for distributing the electronic messages. The method involves providing at least one electronic message or a portion thereof and receiving at least one spam notification signal related to said electronic message or said portion thereof. A portion of an electronic message may e.g. comprise one or more fields of the electronic message or a new portion assembled on the basis of fields or characteristics of the electronic message. Access to the electronic message (and/or the portion thereof) and/or to other (previous or future) electronic messages of the same source is restricted in response to receiving said at least one spam notification signal. The number of spam notification signals resulting in the restriction of access to the electronic message may be set. As an example, the number may be set to 50, 25, 10, 5 or even 1 spam notification signal before access to the electronic message is restricted.

In this context, the applicant has realized that the conventional rule set used for recognizing e-mail spam messages is always outdated, despite the regular updates of the rule set provided by the spam filter developers. Ultimately, only human beings will be able to recognize e-mail spam messages. Moreover, the applicant has realized that the improvement of span filters contributes to the increase of the total amount of spam rather than reducing it. The applicant, therefore, proposes to (solely) use spam notification signals from users to detect electronic spam messages and, upon receipt of such a span notification signal, to restrict access to the corresponding electronic message for other (users of) user devices. The server system thus allows that addressees of an electronic message themselves determine what electronic messages are spam messages and that the addressees are subsequently able to determine the access (rights) of other addressees to that message (and possibly other previous and/or future electronic messages from the same source). In other words, the spam notification signal is an order to the server system to restrict access to messages. In case of multiple spam notification signals, each signal can be regarded as a partial order. As an example, the other (users of) user devices may not display or download the electronic message. Spam filters using span recognition rule sets, spam parameters and criteria may be absent in the server system, at least for those electronic messages for which a spam notification signal has been received.

Spam notification messages may be set or received for other services than electronic mail, where the system or the recipient/destination party finds a person abuses the system.

For example, for telephony services, a system and method can be applied for establishing a telephone connection between a first subscriber device (A-subscriber device) and a second subscriber device (B-subscriber device) in a telephone system. The telephone system is arranged for connecting the A-subscriber device (the calling party) and the B-subscriber device (the called party). The method includes receiving a request from the A-subscriber device to establish a connection with the B-subscriber device and also receiving a personal identity code of a user of said A-subscriber device. The connection can be established between the A-subscriber device and the B-subscriber device only after having received said personal identity code of said user of said A-subscriber device.

By receiving a personal identity code of a user, the telephone system is able to actually recognize the person that is requesting services of the system instead of only recognizing the device that is used. Consequently, the telephone system can apply measures to a particular user instead of only to a device as a result of the received authentication information. In other words, measures applied to a particular user cannot be avoided or circumvented by using a different device. An example of such a measure may be restricting the access of a particular user to services of the telecommunication system.

In order to make spam notification, the system and method may allow receiving one or more access restriction signals and restrict access to at least one of said telephone system and a user of said A-subscriber device or said B-subscriber device for at least one of said user of said A-subscriber device and said user of a B-subscriber device in response to receiving said one or more access restriction signals.

The user of the B-subscriber device has the possibility to restrict access to the telephone system for the user of the A-subscriber device if the telephone call is perceived by the user of the B-subscriber device as unsolicited or undesired. Access is restricted on the basis of the personal identity code of the user of the A-subscriber device and, therefore, this user cannot simply circumvent this measure by using a different A-subscriber device. The personal identity code may e.g. be stored such that further attempts to establish a connection by the person owning the code are first checked against this storage before a connection can be established.

The telephone system spam notification method and system is the subject of a non-prepublished patent application PCT/NL2007/050553 of the applicant which is incorporated in the present application in its entirety.

The system item relating to spam may be set in the above-described manner. The system and/or users may determine whether this spam item relates to a single service or to multiple services.

Of course, a possibility exists that the items of the user profile or recipient profile do not appropriately reflect the personal details. For example, a user or recipient item may indicate that the user or recipient is female at the age of 20, while in fact he is a 45-year old male. As another example, a user or recipient item may indicate that his bank balance is below 50000 Euros, whereas in fact his bank balance is above 100000 Euros. To that end, the server system 1 distinguishes between verified items and unverified items. As an example, if the server system 1 offers payment services itself, an item relating to the bank balance of a user or recipient can be verified internally, since the bank balance is recorded in the server system 1. In other cases, such as gender or age, verification may be performed by checking external registers, requiring users and recipients to submit a copy of the passport etc. to verify the validity of the item. Verification of unverified items may also take place by verifying changes in the items, such as changes in age or gender. Age should always change upwards with one year at the time, whereas gender generally would not change at all. If such items change in an unexpected manner, the items may be set to be unverified, either indefinitely or not. As a severe measure, the complete profile may also be marked as not trustworthy.

In order to increase certainty, the server system 1 comprises a verification indication receiver 37 configured for receiving and processing a verification indication from a device 2A, 2C of the user and/or a device 2B, 2D of a recipient. By means of the verification indication, the user and/or recipient may indicate that one or more criteria of the requirement list(s) should relate to verified item(s) of the profile(s).

Although the items are safely secured within the server system 1 and cannot be requested as such from outside the server system 1, in principle it would be possible to obtain an estimate of one or more items, e.g. one's bank balance, by making various requests to the server system 1 sending a contact identifier of this person. The server system 1 may therefore be configured such that items of the profiles of the user and/or the recipient are by default prevented from checking. Furthermore, the server system 1 comprises a checking prevention indication receiver 38 configured for receiving and processing a checking prevention indication from a device 2A, 2C of a user and/or a device 2B, 2D of a recipient. The checking prevention indication indicates a request from a user and/or recipient that one or more items of said profile are prevented from checking by the analyser 36.

In the server system 1 as described above, there exist various situations wherein an item is not available for checking against a criterion. Examples include the situation wherein a profile does not contain an item required for checking against a criterion of a requirement list (e.g. when the item is not filled in or does not even exist) and the situation wherein an item is prevented from checking by the default setting or by a checking prevention indication signal (see previous paragraph). In order to allow the user or recipient to decide to be engaged in the service, the server system 1 comprises a notification transmitter 39 configured for transmitting a notification request to a device 2A-2D of the user or recipient from whose profile the check would be made, e.g. by means of a pop-up screen on the device. The notification request may present an option to ignore e.g. the checking prevention indication to permit checking of said at least one item against a corresponding criterion of a requirement list or to fill in an item. If the user/recipient permits checking, the prevention indication may be lifted either permanently or temporarily by the server system 1 receiving such an instruction from the devices 2A-2D. As an example, if a user desires to communicate with a recipient by telephone and the recipient requirement list indicates that this is only possible if the bank balance of the user is checked as an item on the user profile list against a corresponding criterion on the recipient requirement list, the user should first permit checking of his bank balance before the communication is established. The release of the checking prevention indication does not mean that this information is communicated to the other party. It only involves the availability of an item for a check against the criteria of a requirement list. Of course, the recipient may also unblock his items if desired, e.g. for marketing purposes.

Items and criteria may be set to apply for one or more services using service selector 39A.

FIG. 4 shows a flow chart containing various steps of a method of permitting or denying service, e.g. service initiation or service establishment. In step 40, the receiver 24 receives a contact identifier of the recipient from the user device 2A. The contact identifier may be a telephone number, an e-mail address, a bank account number, a URL, a home address, a navigation location, a PUID etc. In step 41, the requirement list of the recipient is traced in the database 23 on the basis of the received contact identifier. The requirement list may also be retrieved from another location. Also the profile of the user is traced, e.g. on the basis of login data received by the login module 34A.

A check is then made by the analyser 36 whether or not all criteria of the recipient requirement list are satisfied by corresponding items of the user profile. If the criteria are met, service initiation or service establishment is allowed (step 42). Otherwise, service initiation or service establishment is denied.

Two cases may be distinguished.

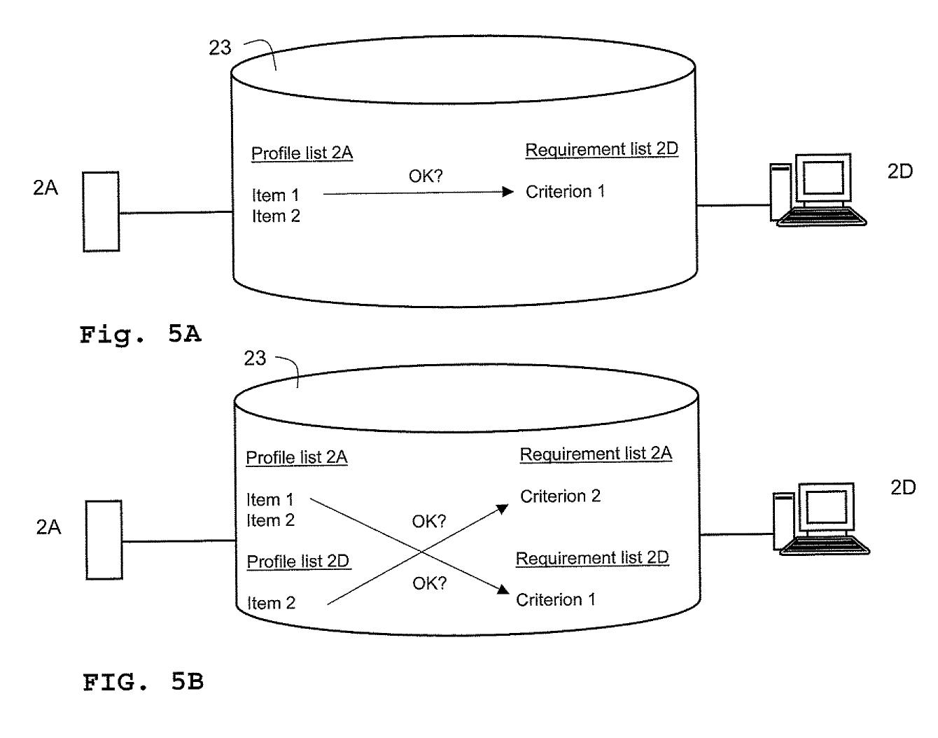

In a first case, shown in FIG. 5A, the analyser 36 only compares the one or more items of the profile of the user of the device 2A, 2C with the appropriate corresponding criteria of the intended recipient. If the items of the user profile fulfil the corresponding criteria of the recipient requirement list, service is allowed. As an example, the payment service initiator 25 and/or the communication service initiator 26 are activated. Other services that may be initiated are streaming media services, a regular mail service and/or a navigation service. On the other hand, if the items do not fulfil the criteria, service initiation or establishment are denied, i.e. use of the payment service and/or the communication service by the user with respect to the particular recipient is denied. This type of analysis is suitable for white listing and/or blacklisting approaches.

In a second case, shown in FIG. 5B, the analyser 36 not only makes the above comparison, but also analyses whether or not one or more items of the recipient profile fulfil criteria of the user requirement list. Service is denied if a user item of the user profile does not satisfy a recipient criterion of the recipient requirement list and/or if a recipient item of the recipient profile does not satisfy a user criterion of the user requirement list. Only if the items fulfil the criteria in both directions, the service initiation is permitted. This case can be referred to as a handshake case or a mutual approval case.

The server system 1 of FIG. 6 is an embodiment comprising multiple servers 1A-1C, wherein server functions and/or data are e.g. distributed over multiple servers connected by secured network connections 50. In FIG. 6, a payment service, a communication service, a regular mail service and/or a navigation service is executed by an external system 51. The external system 51 may be connected via a gateway (not shown) to the server system 1. Items and criteria may be distributed over the servers 1A-1C and be retrieved from the various servers 1A-1C upon request of a service. Such an embodiment may e.g. be useful to safeguard privacy.

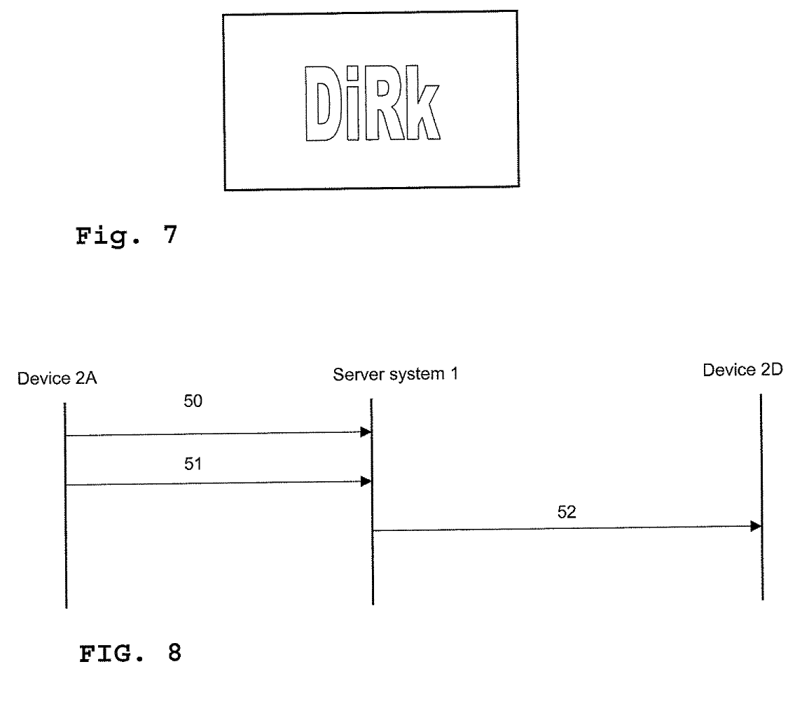

The operation of the server system 1 will now be described for several practical situations with reference to FIGS. 7-14.

First, it is assumed that a business transaction is to be arranged between Ghislaine (user) and Dirk (recipient). Ghislaine only has a business card of Dirk as shown in FIG. 7 displaying the PUID “DiRk”. Of course, other contact identifiers may also be displayed on the business card, such as a telephone number, an address, an e-mail address etc.

The below table shows details of Dirk and Ghislaine stored in the database 23 of the server system 1.

Name

| | Ghislaine | Dirk |
|---|---|---|
| PUID | Ghisje | DiRk |
| Username | ***** | **** |
| Password | ***** | **** |
| Telephone number | +31 20 51 10 930 | |
| Bank account | | 50.37.56.587 |
| E-mail address | | |
| Website | | www.scipioo.com |

FIG. 8 shows the situation wherein Ghislaine attempts to contact Dirk by telephone. She logs in on the server system 1 using login module 34A with her user name and password in step 50. Then, in step 51, she makes a phone call using the PUID “DiRk” which is received by the PUID receiver 24. The database does not store a separate telephone number for the device 2B of Dirk and the determination module 31 determines that Dirk uses the telephony service of the server system 1 (e.g. using an internal code). The analyzer 36 then checks whether items of Ghislaine's profile satisfy corresponding criteria of Dirk's requirement list as described with reference to FIG. 4. If this is true, the telephone connection can be made in step 52 via the telephony service initiator 26 using the PUID of Dirk, or a derivative thereof, as the telephone number of device 2B if the device accepts such a request. In this case, the telephone device does not require a traditional SIM card. However, it is also possible to convert the PUID “DiRk” to a traditional telephone number (available in the system, e.g. entered in the table) using converter 28 and connect to the traditional telephone number of device 2B. Ghislaine and Dirk may now discuss the business transaction.

In the telephone conversation, it is discussed that Ghislaine should wire a payment of [symbol] 100 000 to the bank account of Dirk. Ghislaine is not aware of the bank account number of Dirk.

In FIG. 9, Ghislaine logs in on the server system 1 using login module 34A again using device 2A in step 60. Of course, logging in would not necessarily be required twice if the connection with server system 1 was maintained. The server system 1 presents an interface of the display 11 using a first session key. Ghislaine again enters the PUID “DiRk” to make the payment to Dirk in step 61 and the server system 1 presents a further screen to enter a payment amount under a second session key, different from the first session key. The second screen may only be presented if Ghislaine's profile items satisfy Dirk's criteria as known from his requirement list. The payment amount of [symbol] 100 000 is received by the server system 1 in step 62. Of course, the payment amount may also be received by the server system 1 in step 61, i.e. together with the PUID of the recipient.

The determination module 31 determines that Dirk does not use the bank services of the server system 1, since Dirk has filled in an external bank account number in the table. In response to this determination, the payment service initiator activates the payment connection module 29 to make the payment to an account on an external bank system 51 (FIG. 6) in step 63. Dirk may now use his device 2D to check with his bank 41 whether or not the payment has been made (step 64).

The profiles and requirement lists of Ghislaine and Dirk are provided in the below table.

| | Profile PUID (Ghisje) | Profile PUID (DiRk) |
|---|---|---|
| Gender | Female | Male |
| Age | 25 | 45 |
| Bank balance | BLOCKED | [symbol] 1 500 000 |
| Industry | ICT (not verified) | ICT |
| SPAM notification | YES | NO |

| Requirement list Ghisje | Requirement list DiRk |
|---|---|
| Industry = ICT | Industry = ICT |
| | (verification |
| | required) |
| | Bank balance > |
| | [symbol] 50 000 (for |
| | payment services) |

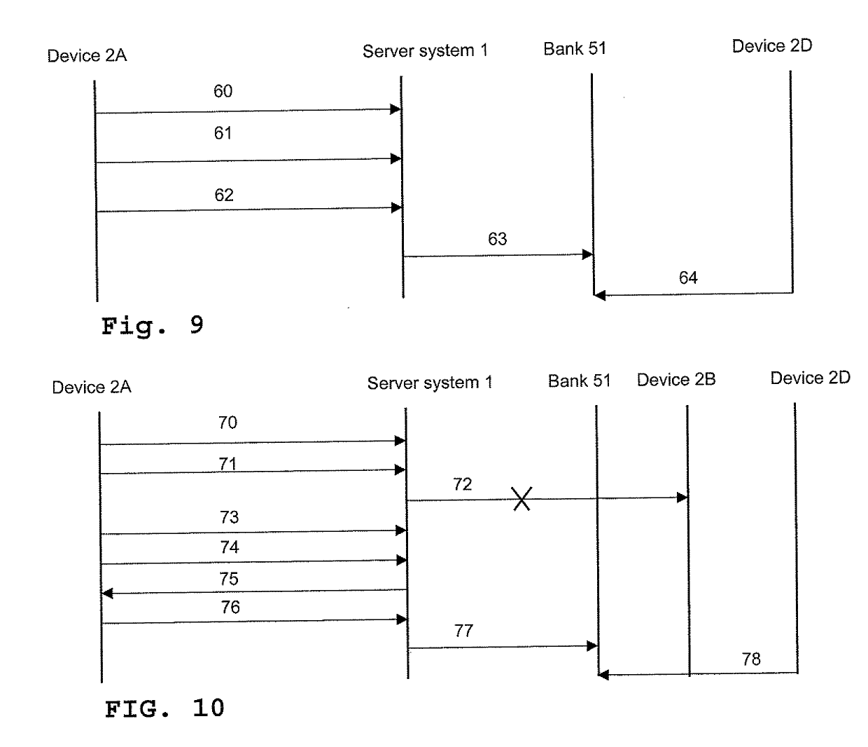

FIG. 10 shows a login step 70 of Ghislaine using the login module 34A for verifying the user name and password. In step 71, a composed message containing the PUID “DiRk” and an indication that a telephony service is requested is received by the PUID receiver 24 in combination with the communication type message receiver 27. Of course, steps 70 and 71 may also relate to a simple telephone call containing the telephone number of Dirk that is picked up by the system 1.

The PUID “DiRk” is used by the tracer 35 to trace the requirement list of Dirk. The requirement list comprises a first criterion relating to the type of industry the other party should be involved in, viz. information and communications technology industry (ICT). This criterion should be fulfilled for all services. Moreover, the industry item of the profile of the other party (in this case Ghislaine) should be a verified item. The requirement list of Dirk comprises a second criterion prescribing that the bank balance of the other party should be higher than [symbol] 50 000. However, this criterion is only relevant for payment services, which has been set using the service selector 39A. Dirk may have entered these criteria in the server system 1 before the login step 70.

In the present case, the telephony service will not be initiated, since the analyser 36 will find that, although the industry item in the profile of Ghislaine is ICT, this is not a verified item, such that the analyser will not instruct the telephony service initiator 26 to initiate a telephone connection (indicated by the cross in step 72).

This situation will force Ghislaine to have the industry item of her profile verified in the server system 1, e.g. by submitting contract details to the moderator of the server system 1. If this item is verified, a telephone connection between device 2A and device 2B can be established via the telephone service initiator 26 in accordance with the case of FIG. 8.

It should be noted that if Dirk's requirement list would have contained a criterion that Ghislaine should not have been notified as a spammer on the server system 1, the analyser 36 would have never triggered the telephone service initiator 26, since Ghislaine's profile list includes a system item indicating that she has received a spam notification. This item is by default a verified item that could not be prevented from checking by the analyser 36. The system item may either be valid for only one service or for multiple services. In a practical situation, it is envisaged that a spam criterion is by default part of the requirement list of any user and recipient (but may be removed from this list, as Dirk has done in the present example).

After the telephone conversation, Ghislaine again desires to wire a sum of [symbol] 100 000 to the (external) bank account of Dirk. Ghislaine submits the PUID “DiRk” to the server system 1 in step 73 together with an indication message that a payment service is required. This indication may be implicit by entering the amount of [symbol] 100 000 in an amount field on the display 11, which amount is received in step 74. The PUID, the indication and the amount field may be received in a single composed message. It is not required that the PUID is sent for each service separately.

After tracing the requirement list of Dirk using tracer 35 on the basis of the PUID of Dirk, the analyser 36 finds that Dirk's requirement list also has a criterion, that should only be checked for payment services, wherein the other party has a bank balance of at least [symbol] 50 000. When checking the corresponding item in the profile of Ghislaine, the analyser finds that this item is prevented from checking. This may be the default setting or may be set by Ghislaine using the checking prevention indication receiver 38 of the server system 1 (see table: BLOCKED). It should be appreciated that all items and criteria are not communicated to users of the server system 1 as such, but may be available for checking by the analyser 3G, if not prevented. Consequently, the analyser 36 can not perform the check for the bank balance of Ghislaine in this case. The analyser 36 can again perform the check of the industry requirement. It is noted that if the bank balance requirement was also applicable for other services, such as the telephony service, the telephony service was not initiated before allowing the check of the bank balance (and if the bank balance was found to be insufficient, a telephony service would not be initiated). That is, criteria may either be applicable to one service or to a plurality of services.

Ghislaine may have chosen an option that in such a case, the notification transmitter 39 of the server system 1 notifies her, step 75, of the fact that Dirk's requirement list requires checking of her bank balance before a payment can be made. She may then chose to (temporarily) permit checking of her bank balance item, step 76. Subsequently, the analyser 36 may perform the check against the bank balance criterion of Dirk's requirement list and trigger the payment service initiator 25 to start the payment transaction (steps 77, 78 in accordance with steps 63, 64 of FIG. 9).

FIG. 11 provides yet another example of a method for permitting or denying service.

Deirdre and Henk have agreed to make a phone call. Henk uses his device 2B. The system 1 in step 80 receives the telephone number of Deirdre and tracer 35 traces the requirement list of Deirdre on the basis of the telephone number. The profile of Henk is also traced and the analyser 36 checks whether the items of Henk's profile satisfy the applicable corresponding criteria of Deirdre's requirement list. It is assumed that the analyser 36 finds that the items of Henk's profile satisfy the criteria of Deirdre's requirement list.

However, the system 1 has been set that mutual approval is required for initiating this service and, therefore, the telephone communication is not yet effected (indicated by the cross in step 81).

At a later moment, Deirdre contacts the system 1 (step 82) using Henk's telephone number. The tracer 35 now traces Henk's requirement list and the analyser 36 checks whether Deirdre's items match the criteria of Henk's requirement list. If the analyser 36 finds that the items of Deirdre's profile satisfy the criteria of Henk's requirement list, telephone communication may be initiated (step 83), either directly after the check or at a later time.

The embodiment of FIG. 11 uses the mutual approval method described with reference to FIG. 5B. It should be appreciated, however, that mutual approval does not necessarily require both parties to contact the system 1. In the above example, Henk's call would allow both checks to be made on the basis of the telephone number of Ghislaine and the contact details of Henk (e.g. his login data, a telephone number, the IMEI code etc.).

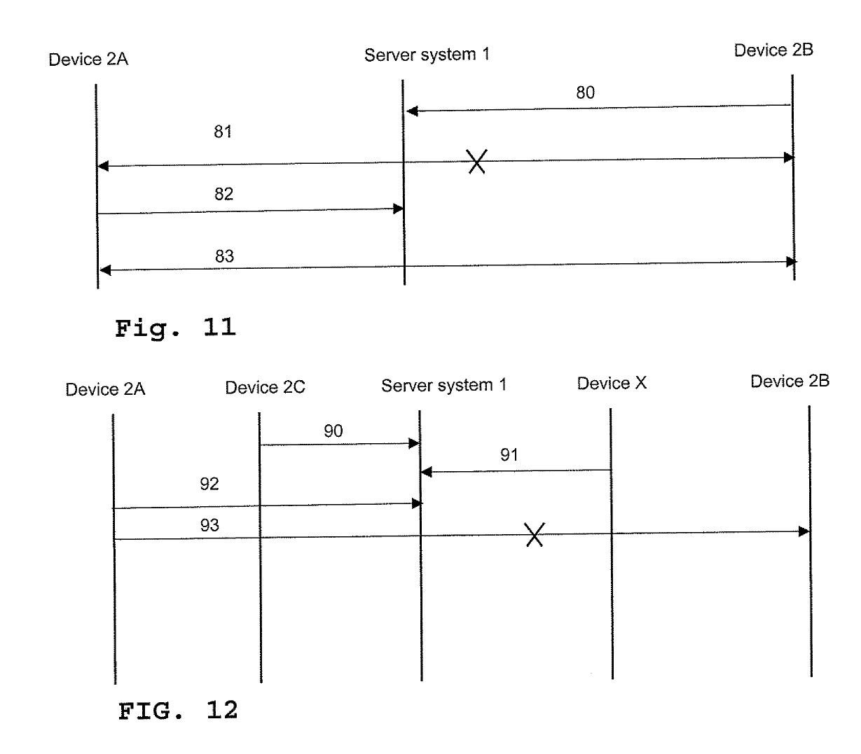

FIG. 12 shows a case wherein a user sends a spam e-mail from his user device 2C (step 90). In step 91, the system 1 receives a spam notification message of an arbitrary user device X. The spam notification message may be obtained in a manner described in the non-prepublished international patent applications PCT/NL2007/050557 and PCT/NL2007/050555 of the applicant which are incorporated in the present application by reference in its entirety. The profile of the user now has a system item reflecting that the user has been notified as a spammer. In step 92, the user makes a telephone call to recipient device 2B with his mobile phone 2A. The tracer 35 of the system 1 traces the recipient requirement list of the recipient. The analyser 36 finds out that the recipient requirement list contains a criterion that the recipient would not like to be involved in a service initiated by someone that is registered as a spammer. Consequently, a telephone connection will not be established, indicated by the cross in step 93.

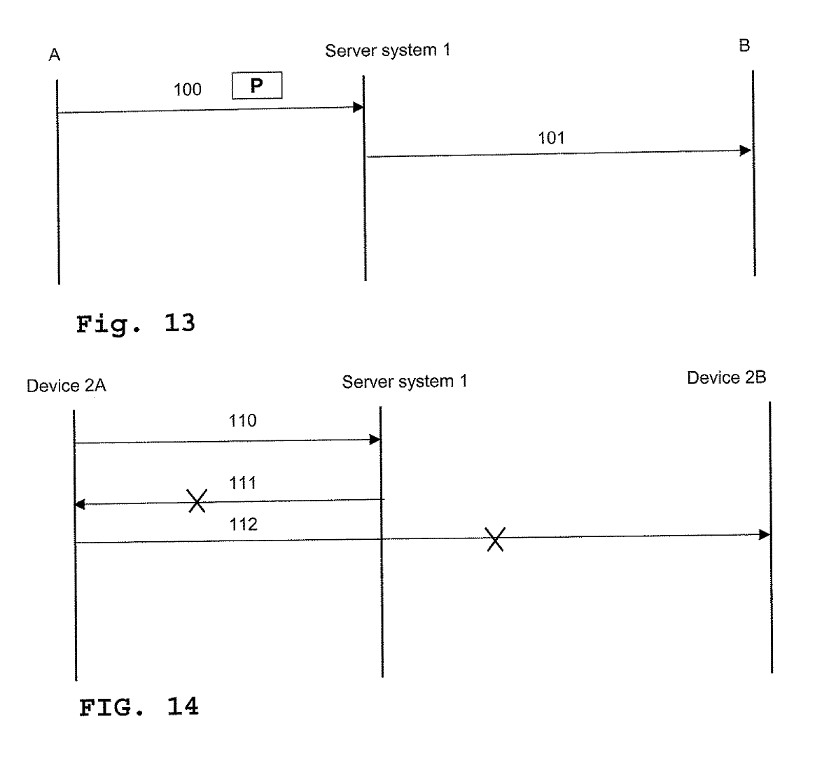

In FIG. 13, a user A sends a letter or parcel P to a company having access to the server system 1 (step 100). The letter contains a PUID (or another contact identifier) of an intended recipient B. The PUID is scanned and if the items on the profile list of user A satisfy the corresponding criteria of the requirement list of recipient B, the actual address of the recipient B is released by the system and the letter or parcel P can be delivered to the recipient at this address (step 101). Of course, the user A may also send the PUID to the server system and obtain the address of only if his item(s) satisfy the criteria of the recipient requirement list of B. Payment can also be arranged via the server system 1.

In FIG. 14, a user A enters a PUID (or another contact identifier) of an intended location of another party B into his navigation device 2A (not necessarily a mobile phone). The navigation device 2A sends a request to the server system containing the PUID for route information to this location (step 110). On receipt of the request, the analyser 36 checks whether the items on the profile list of user A satisfy the corresponding criteria of the requirement list of recipient B. As an example, the criterion of the requirement list of B is that navigation information should not be provided to patent attorneys. Since the profession item of user A indicates that user A is a patent attorney, navigation information is not provided to the navigation device 2A (indicated by the cross in step 111). Therefore, the patent attorney A will not be able to navigate to B using his navigation device 2A (indicated by the cross in step 112).

It should be noted that many more examples have been envisaged of practical applications of the contact identifier, the profiles with items and the requirement lists with corresponding criteria. Practical applications include marketing applications, dating site applications, etc. One or more items of profiles may be unblocked permanently or permanently in exchange for e.g. free communication, free banking or other advantages. All such applications fall under the scope of protection of the present patent application.

Although the subject matter has been described in language specific to structural features and/or methodological acts, it is to be understood that the subject matter defined in the appended claims is not necessarily limited to the specific features or acts described above as has been determined by the courts. Rather, the specific features and acts described above are disclosed as example forms of implementing the claims.

1. A computer-implemented method of permitting or denying service for a user device of a user in relation to a recipient in a server system configured for connecting with said user device, wherein the server system has access to a recipient requirement list of said recipient and a user profile of said user and wherein said recipient requirement list comprises at least one criterion regarding an item of said user profile, the method comprising the steps of:
receiving a service request from said user device, said service request comprising a contact identifier of said recipient;
tracing said recipient requirement list on the basis of said contact identifier;
checking whether said item of said user profile satisfies said at least one criterion of said traced recipient requirement list; and
permitting said service if said item of said user profile satisfies said at least one criterion of said recipient requirement list and denying said service if said item of said user profile does not satisfy said at least one criterion of said recipient requirement list.

2. The method according to claim 1, wherein said server system has access to a user requirement list of said user and a recipient profile of said recipient and wherein said user requirement list comprises at least one criterion relating to an item of said recipient profile, the method further comprising the steps of:
tracing said user requirement list;
checking whether said item of said recipient profile satisfies said at least one criterion of said traced user requirement list;
permitting said service only if said item of said recipient profile also satisfies said at least one criterion of said user requirement list.

3. The method according to claim 2, further comprising the step of tracing said user requirement list on the basis of at least one of login data received from said user device and from a contact identifier received from a device of said recipient.

4. The method according to claim 1, wherein said server system is configured for permitting or denying service for at least a first service and a second service, the method comprising the step denying said service initiation of said first service and said second service if said item of said user profile does not satisfy said at least one criterion of said recipient requirement list.

5. The method according to claim 4, wherein said server system has access to a user requirement list of said user and a recipient profile of said recipient and wherein said user requirement list comprises at least one criterion relating to an item of said recipient profile, the method further comprising the steps of:
tracing said user requirement list;
checking whether said item of said recipient profile satisfies said at least one criterion of said traced user requirement list;
permitting service of said first service and said second service only if said item of said recipient profile also satisfies said at least one criterion of said user requirement list.

6. The method according to claim 4, further comprising the step of receiving a service selection in at least one of said user requirement list and said recipient requirement list.

7. The method according to claim 1, wherein said criterion is independent of said contact identifier of said recipient.

8. The method according to claim 1, wherein said at least one item comprises a system item and/or a user defined item.

9. The method according to claim 8, wherein said system item is a spam related item.

10. The method according to claim 1, wherein said items of said profile(s) comprise verified items and unverified items.

11. The method according to claim 10, wherein said server system receives from at least one of a device of said user and a device of said recipient a verification indication that said at least one criterion of said requirement list relates to a verified item or an unverified item of said profile.

12. The method according to claim 1, wherein one or more of said items are prevented from checking and wherein, optionally, said server system receives from at least one of a device of said user and a device of said recipient a checking prevention indication indicating that one or more items of said profile are prevented from checking.

13. The method according to claim 12 comprising the step of transmitting a notification request to a device of the user or recipient for whom a checking prevention indication applies, said notification request presenting an option to ignore said checking prevention indication to permit checking of said at least one item against a corresponding criterion of a requirement list.

14. The method according to claim 1, wherein said server system is configured for initiating at least a first service and a second service and said contact identifier comprises a public unique identifier suitable for use in both said first service and said second service.

15. The method according to claim 14, wherein said server system is configured for a first service and a second service in relation to said same recipient, the method comprising the steps of:
receiving said public unique identifier of said recipient;
receiving a message indicating a request for said first service and initiating said first service relating to said recipient on the basis of said public unique identifier;
receiving a message indicating a request for said second service and initiating said second service relating to said recipient on the basis of said public unique identifier.

16. The method according to claim 1, wherein said service(s) include two or more of the following services: a payment service, a telephony service, an electronic messaging service, a streaming media service, a web browsing service, a regular mail service and a navigation service.

17. The method according to claim 15, further comprising the steps of:
converting said public unique identifier to at least one of a payment address identifier and a communication address identifier;
connecting to a payment system for initiating said payment service using said payment address identifier;
connecting to a communication system for initiating said communication service using said communication address identifier.

18. The method according to claim 15, wherein said server system provides at least one of said first service and said second service, said method comprising the steps of:
determining whether said recipient uses said at least one of said first service and said second service at said server system;
initiating said at least one of said first service and second service using said public unique identifier as at least one of a first service address identifier and a second service address identifier.

19. The method according to claim 1, further comprising the step of receiving a login request from a payment device or communication device, said login request comprising at least one personal identifier.

20. The method according to claim 19, wherein at least said login request is transmitted over a network to said server system in a secure manner.

21. A computer program comprising software code portions adapted for, when installed on and executed by an electronic system, performing the method according to claim 1.

22. A carrier containing the computer program of claim 21.

23. A server system configured for permitting or denying service, said server system being configured for connecting with a user device of a user in relation to a recipient, wherein the server system comprises:
a receiver configured for receiving a service request from said user device, said service request comprising a contact identifier of said recipient;
a tracer configured for tracing a recipient requirement list of said recipient on the basis of said contact identifier, said recipient requirement list comprising at least one criterion regarding an item of a user profile;
an analyzer configured for analyzing whether said item of said user profile satisfies said at least one criterion of said traced recipient requirement list; and
a service initiator configured for permitting said service if said item of said user profile satisfies said at least one criterion of said recipient requirement list and denying said service if said item of said user profile does not satisfy said at least one criterion of said recipient requirement list.

24. The server system according to claim 23, wherein:
said tracer is further configured for tracing a user requirement list of said user and a recipient profile of said recipient, said user requirement list comprising at least one criterion relating to an item of said recipient profile;
said analyzer is further configured for analyzing whether said item of said recipient profile satisfies said at least one criterion of said traced user requirement list;
said service initiator is configured for permitting said service only if said item of said recipient profile also satisfies said at least one criterion of said user requirement list.

25. The server system according to claim 24, wherein said system comprises a login module for receiving login data and said tracer is configured for tracing said user requirement list on the basis of said login data or on the basis of a user identifier received from a device of said recipient.

26. The server system according to claim 23, wherein said server system is configured for permitting or denying service for at least a first service and a second service and said service initiator is configured for denying said service initiation of said first service and said second service if said item of said user profile does not satisfy said at least one criterion of said recipient requirement list.

27. The server system according to claim 26, wherein said server system has access to a user requirement list of said user and a recipient profile of said recipient and wherein said user requirement list comprises at least one criterion relating to an item of said recipient profile, wherein said service initiator is configured for permitting service of said first service and said second service only if said item of said recipient profile also satisfies said at least one criterion of said user requirement list.

28. The server system according to claim 26, wherein said server system further comprises a service selector configured for containing a service selection in at least one of said user requirement list and said recipient requirement list.

29. The server system according to claim 23, wherein said criterion is independent of said contact identifier of said recipient.

30. The server system according to claim 23, wherein said at least one item comprises a system item and/or a user defined item.

31. The server system according to claim 30, wherein said system item is a spam related item.

32. The server system according to claim 23, wherein said items of said profiles comprise verified items and unverified items.

33. The server system according to claim 32, further comprising a verification indication receiver configured for receiving and processing a verification indication from at least one of a device of said user and a device of said recipient, said verification indication indicating that said at least one criterion of said requirement list relates to a verified item of said profile.

34. The server system according to claim 23, wherein one or more of said items are prevented from checking, the system optionally comprising a checking prevention indication receiver configured for receiving and processing a checking prevention indication from at least one of a device of said user and a device of said recipient, said checking prevention indication indicating that one or more items of said profile are prevented from checking by said analyser.

35. The server system according to claim 23, wherein said system further comprises a notification transmitter configured for transmitting a notification request to a device of the user or recipient for whom a checking prevention indication applies, said notification request presenting an option to ignore said checking prevention indication to permit checking of said at least one item against a corresponding criterion of a requirement list.

36. The server system according to claim 23, wherein the system is configured for providing a first service and a second service with said same recipient, wherein said receiver is a public unique identifier receiver configured for receiving a public unique identifier of said recipient suitable for use in both said first service and said second service.

37. The server system according to claim 36, wherein said server system further comprises:
a first service initiator configured for receiving a message indicating a request for said first service and initiating said first service relating to said recipient on the basis of said public unique identifier;
a second service initiator configured for receiving a message indicating a request for said second service and initiating said second service relating to said recipient on the basis of said public unique identifier;

38. The server system according to claim 23, wherein said service(s) include at least one of a payment service, a telephony service, an electronic messaging service, a streaming media service, a web browsing service, a regular mail service and a navigation service.

39. The server system according to claim 23, wherein said server system further comprises:
a converter configured for converting said public unique identifier to at least one of a first service address identifier and a second service address identifier;
a first service connection module for connecting to a first service system for initiating said first service using said first service address identifier;
a second service connection module for connecting to a second service system for initiating said second service using said second service address identifier.

40. The server system according to claim 23, further comprising:
a first service module configured for executing a first service in relation to said recipient;
a second service module configured for executing a second service in relation to said recipient;
a determination module configured for determining whether said recipient uses said at least one said first service and said second service;
and wherein at least one of said first service module is configured for initiating said first service using said public unique identifier as a first service address identifier and said second service module is configured for initiating said second service using said public unique identifier as a second service address identifier.

41. The system according to claim 23, further comprising a login module configured for receiving a login request from a payment device or a communication device, said login request comprising at least one personal identifier.

42. The system according to claim 41, wherein said login module is configured for receiving said login request in a secure manner.
